(19) United States
(12) Patent Application Publication
(10) Pub. No.: US 2024/0065450 A1
(43) Pub. Date: Feb. 29, 2024

(54) Adjustable Cushion with Tension Device

(71) Applicant: STEVEN MURRAY, CASTLE HAYNE, NC (US)

(72) Inventor: STEVEN MURRAY, CASTLE HAYNE, NC (US)

(21) Appl. No.: 17/895,735

(22) Filed: Aug. 25, 2022

(51) Int. Cl. A47C 27/06; A47G 9/10

(52) U.S. Cl. CPC A47C 27/061; A47G 9/10

(57) ABSTRACT

A tension device integrated into a pillow or cushion that allows the user to manually adjust the internal arrangement and thus the thickness and firmness of the pillow by pulling on one or more cords that are attached at various locations inside or on the outside of the pillow and run through at least a portion of the interior of the pillow. The cord(s) attach to a portion of the inside or outside of the pillow, then traverse the interior of the pillow to exit a different side of the pillow than the one to which they are attached. The user then pulls on the cord(s) pulling one side of the pillow towards another and then secures the free ends of the cord(s) when the desired firmness is achieved.

### BACKGROUND OF THE INVENTION

### (A) Field of the Invention

The present disclosure is in the field of bedding; more specifically, the present disclosure relates to a cushion with a tension device that allows the user to adjust the firmness of the cushion without opening the cushion. The cushion can be a pillow, mattress or any other device that consists of a fabric material being stuffed with a soft material to provide support to some portion of a person's body. For simplicity, the cushion will be referred to as a pillow throughout the following description.

### (b) Background Art

A good pillow can be essential to a good night's rest. The purpose of a pillow is to provide support for your head, neck and/or shoulders while sleeping. Different kinds of pillows provide different levels of support depending on the materials out of which the pillow is made and their shape and size. A lot of people have trouble finding a pillow that is the right size and shape for them and frequently use more than one pillow to attempt to solve the problem. A pillow that does not provide the right amount of support to a user's head and neck can lead to neck discomfort and poor sleep.

Because different people have different preferences for the size, shape and density of their pillows, over the years people have come to make pillows that are adjustable. One of the most basic solutions to the problem of adjusting a pillow's shape and thickness comes in the form of segmented pillows such as those described in U.S. Pat. No. 395,043 issued to William Doremus. That reference describes pillows with more than one section or segment. Each section or segment has a different amount of or type of stuffing therein giving each section or segment a different thickness and shape. The user simply selects the section or segment that they desire to use and places their head on that segment. This design is simply not versatile enough to allow a user to fully customize the shape and firmness of their pillow.

Other devices allow the user to insert or remove additional padding into the pillow to suit the user's needs. For example, U.S. Pat. No. 5,953,777 issued to Ronald Mark Buck describes a pillow that holds multiple, removable padded inserts that the user can insert or remove from the pillow to adjust the height and firmness of the pillow. This design necessarily forces the user to open the pillow and remove or replace cushions that have to be stored separately from the pillow.

Another variation on this concept is disclosed by U.S. Pat. No. 6,691,352 issued to Long-Win Wang and shows a pillow that has a plurality of compartments. Three of these compartments communicate with a fourth compartment that is positioned to rest under the user's neck. The user can move stuffing from one compartment to another in order to shape the pillow in the desired manner. However, this configuration still requires the user to move stuffing from one portion of the pillow to another.

Still another solution to the problem of needing to adjust a pillow's firmness and height is described in U.S. Pat. No. 6,141,807 issued to David Tapper. This reference described a roughly cylindrical pillow that has encircling belts that can be cinched tightly or loosely around the midsection of the pillow thereby changing its firmness and height.

None of these designs allows a user to fully customize the shape and firmness of the pillow or cushion without opening the pillow. As a result, there exists a need in the industry for a pillow the shape and/or firmness of which can be adjusted without adding and removing inserts from the interior of the pillow, wrapping belts around the exterior of the pillow or moving stuffing from one portion of the pillow to another.

### BRIEF SUMMARY OF THE INVENTION

The present invention is a tension device for a cushion or pillow that allows the user to alter the thickness and firmness of the pillow by manipulating the interior of the pillow without adding or removing padding from the same pillow interior. More specifically, the inventor has devised a number of ways of adjusting the thickness and firmness of a pillow without opening the pillow or adding or removing any of its contents. None of these designs require the user to move padding from one portion of the pillow to another or include multiple pillows attached to each other as described in the patent issued to William Doremus.

Pillows can come in a variety of sizes and shapes, but for convenience this disclosure will refer to a square or rectangular shaped pillow having knife edges¹ or box edges². Knife edge pillows have a top and bottom surface that come together to form edges that encircle the top and bottom surfaces of the pillow and enclose the pillow stuffing or the cushioning that takes up the interior of the pillow formed when the edges are joined together. That type of pillow can be said to have two side edges as well as a top and a bottom edge. Box edge pillows are similar, but have two to four vertical side walls that are joined to the top and bottom surfaces of the pillow and form flat sides. For convenience, a rectangular pillow will be used to illustrate a number of the embodiments. A skilled artisan will readily appreciate how this disclosure can be adapted to be used in pillows having different shapes and sizes. ¹ The term knife edge pillow refers to a simple seam technique. The seam is made by sewing two pieces of fabric together along the ends to create a sharp knife-like edge. No decorative finish or trim is added to this seam. When using this edge for pillow shams, a hidden zipper closure or envelope closure can be used. https://knowledgebank.materialbank.com/terms/knife-edge-pillow² Boxed Edge Cushion styles with a Boxed Edge are constructed with a vertical sidewall that is the same height as the thickness of the cushion. These types of cushions are made by assembling the top and bottom section of the cut fabric to the sidewall fabric to form a box. https://firstlawcomic.com/what-is-a-boxed-edge-cushion/

In a first embodiment, a tension device includes an elongated structure or length of material such as a string, rope, strap or cord that is attached to one end or edge of the pillow, passes through the interior of the pillow and exits an opposing side or edge of the pillow and includes means to shorten the length of the cord. This embodiment includes at least one cord attached to the interior or exterior of a first edge of the pillow which then passes through the interior of the pillow and passes through a second edge of the pillow that is directly opposite the first edge through holes that are located in the second edge of the pillow. These embodiments may include the cords or straps running through the pillow stuffing rather than around it such that when the cord is shortened, the opposing edge of the pillow moves toward the second edge thereby compressing the stuffing in the pillow and changing the shape and firmness of the pillow. The user pulls on the portion of the cord that passes through the holes in the second edge of the pillow (the “free end” of the cord) to “shorten” or “fluff” the pillow to the desired thickness and firmness.

The device includes a means of locking the cord in place once the user finds the desired positioning of the cord with respect to the pillow. The simplest means of locking the cord in place would be for the user to tie a knot in the end of the cord that is larger than the hole(s) through which the free end of the cord passes. Or, if the pillow has two such cords, the user could simply tie their free ends together. However, several locking mechanisms can be used to hold the cord(s) in place at the point where they exit the pillow including a cord lock that consists of a housing holding a spring in place and that accommodates the insertion of a smaller plunger. Both the plunger and the housing feature complementary holes through which the cord can pass. In this disclosure, the term “feature” means the stated structure is attached to, integrated with, on top of, in contact with or is otherwise a part of the thing that is said to feature the structure. When the cord is inserted into those holes or channels and the plunger is released, the spring forces the plunger upward pinching the cord in place between the housing and the plunger.

Alternately, the free end of a cord or strap can be inserted through a buckle that is attached to an exterior of the pillow. The user can adjust the tension inside the pillow by pulling on the cord and then attach the free end of the cord to a buckle attached to an exterior of the pillow. Other embodiments can include a second cord or strap integrated into the pillow in the same manner as the cord/strap described above. The cords or straps can each feature a locking mechanism or can use one or more locking mechanisms to interact with the other cord. For example, the strap and buckle embodiment above could include a second strap or cord attached to a different portion of the same first edge of the pillow and passing through the same second edge of the pillow. Instead of a buckle being attached to an exterior of the pillow, the buckle could be attached to either of the cords/straps while the other cord/strap could be attached to the buckle and pulled to tighten both cords/straps at the same time. Alternately, each end of the cord or strap could feature one component of a dual side release buckle such that the free ends of the cords/straps can be connected, and the length of the cords or straps manually adjusted.

Other locking means can be used to secure the cords or straps that exit the interior of the pillow. For example, each cord or strap could feature one portion of a hook and loop fastener system. The complementary portion of the hook and look fastener system could be featured on the exterior of the pillow or the other cord or strap. The free end of the cord or strap could be configured to interact with any form of fastener either included on a free end of another cord or strap or on an exterior of the pillow. The cords or straps could also attach to toggles, buttons, snaps, and/or clips. The straps or cords can also feature any number of attachment means including loops or holes that interact with structures on the exterior of the pillow or another cord or strap. Some embodiments feature a handle or other elongated structure outside of the pillow to which the cords or straps can attach. This way a user can pull on both cords or straps at one time. The user can also pull the handles and then roll the cord portion of the straps or cords around the handles and then fasten them in place using one of the locking means described above such as a snap or button. Some variations will have a portion of the locking means on the handle and that is complementary to and configured to interact with the another portion of the same locking means attached to an exterior of the pillow. The user can then lock the cords in place by locking the handle in place on the exterior of the pillow.

In addition to a variety of locking means, the pillow can also feature a number of different internal configurations. First, the straps or cords can be attached to an edge of the pillow as described above, or they can be attached to more than one portion of the pillow. For example, an embodiment has two or more cords that are both attached to an interior surface of a first side edge of a pillow, traverse a portion of the interior of the pillow and then attach to a second portion of the interior of the pillow before continuing to traverse the interior of the pillow until they exit through a second side edge. Another embodiment features additional holes in the top and bottom edges of the pillows such that the cords or straps can traverse the top and bottom edges of the pillow in more than one location before passing through the second side edge of the pillow. Yet another embodiment has at least one cord that passes through the first edge rather than attaching to it. For example, the cord can pass from the interior of the pillow through the exterior of the pillow at one point and then re-enter the same edge of the pillow (or a different edge) before passing through the second side edge of the pillow. Such a configuration will allow a single cord, when pulled from the free end to compress a portion of exterior of the pillow where the cord passes outside of the pillow as well as the interior of the pillow.

As mentioned above, the cords can take on any number of forms as well. One variation of the pillow includes one or more straps that traverse the interior of the pillow and attach and exit in the same manner as described above. The cords may be elastic, but will function even if they are inelastic.

The locking means can also be used to roll of fold the pillow as desired by the user. Any cord or strap that attaches to a portion of the pillow can be pulled and wrapped around an exterior of the pillow.

Similar embodiments may include two rigid or semi-rigid elongated structures that are attached via a third rigid or semi-rigid elongated structure that runs through the interior or the pillow. The first and second structures can be integrated into the pillow or attached to an exterior of the pillow. Alternately, they can simply be attached to the third elongated structure at a point where that third elongated structure exits the pillow. The third elongated structure is configured to shorten when one or both of the first and second elongated structures are manipulated. For example, the first and second structures can be handles that are connected to or feature complementary threaded tubes, rods or columns that traverse the interior of the pillow. One handle features or is attached to an internally threaded tube while the second handle features or is attached to a complementary, externally threaded rod that can be screwed into the internally threaded tube. When the threaded rod is screwed into the threaded tube, the distance between the first and second handles decreases compressing the pillow therebetween. Other versions of this embodiment feature a bolt or knob integrated into the handle that allows the user to turn the threaded tube or rod without turning the entire handle. Still other versions of this embodiment are motorized, i.e. there is a motor that is operably connected to the handles or the knob integrated into a handle or handles that turns the knob for the user. Another variation features a sleeve that fits over the threaded portion of the screw that would otherwise be exposed to the interior of the pillow.

Yet another embodiment or version includes at least one cord or strap attached at one end to a slide that is attached to the exterior of the pillow or integrated into the seam of a pillow. The cord/strap then passes through some portion of the interior of the pillow, exits the opposing edge of the pillow, re-enters a different portion of the same opposing edge or an adjacent edge of the pillow, traverses at least part of the interior of the pillow again and is connected to a pulley that is attached to a surface of the slide or the pillow before connecting to a thumb slide. When the slide is moved by the user, the cord either tightens or relaxes and either compresses or releases the portion of the pillow around which it is positioned.

Different versions of the pillow can also feature different arrangements of the internal pillow stuffing. Another embodiment features compressible accordion like piece of material that folds up neatly when compressed by pulling on the cords or straps running through it.

The present disclosure relates to cushions, pillows and other forms of padding, whether they are made of cloth or some other form so of flexible material such as rubber, plastic, synthetic and natural fibers, etc. The structure and functioning of the device works the same regardless of what materials make up the exterior surfaces of the cushion. Larger devices can be equipped with the same structures to produce similar results. For example, the above structures can be integrated into a mattress, sleeping bag or pad.

### BRIEF DESCRIPTION OF THE SEVERAL VIEWS OF THE DRAWING(S)

FIG. 1 is an x-ray view of a first embodiment of the present invention;

FIG. 2A is an x-ray view of a second embodiment of the present invention;

FIG. 2B is an x-ray view of a variation on the second embodiment shown in FIG. 2A;

FIG. 3 is an x-ray view of a third embodiment thereof;

FIG. 4A is an x-ray view of a fourth embodiment thereof that uses a threaded cylinder;

FIG. 4B is a perspective view of the cylinder of the fourth embodiment;

FIG. 4C is an x-ray view of the same cylinder used in the fourth embodiment;

FIG. 5A is an x-ray view of a motorized version of the fourth embodiment;

FIG. 5B is a perspective view of the motorized threaded cylinder used in the fourth embodiment;

FIG. 6A is an x-ray view of a fifth embodiment of the present invention;

FIG. 6B is an x-ray view of another variation of the fifth embodiment thereof;

FIG. 6C is a top perspective view of the slide mechanism integrated into the pillow in the fifth embodiment;

FIG. 6D is a bottom perspective view thereof;

FIG. 6E is a front perspective view of the thumb slide used in the fifth embodiment;

FIG. 6F is a back perspective view of the thumb slide used in the fifth embodiment;

FIG. 6G is a perspective view of the tracks used in the thumb slide;

FIG. 7A is an x-ray view of a sixth embodiment that uses a ratchet assembly to adjust the internal configuration of the pillow;

FIG. 7B is an x-ray view thereof;

FIG. 8 is an x-ray view of a sixth embodiment that has panels that divide the interior of the pillow into sections;

FIG. 9 is a perspective view of an alternate arrangement for the stuffing inside the pillow that can be used with any embodiment;

FIG. 10A is an x-ray view of a first embodiment of the locking means;

FIG. 10B is an exploded view thereof;

FIG. 11A is an x-ray view of a second embodiment of the locking means;

FIG. 11B is a close-up view thereof;

FIG. 12A is a plan view of a buckle with a strap inserted therein used as a third embodiment of the locking means;

FIG. 12B is a plan view of the buckle alone;

FIG. 12C is a plan view of a buckle with a strap inserted therein

FIG. 12D is an x-ray view of a pillow featuring the third embodiment of the locking means;

FIG. 13A is a perspective view of a fourth embodiment of the locking means;

FIG. 13B is a perspective view thereof;

FIG. 14A is an x-ray view of a fifth embodiment of the locking means;

FIG. 14B is an x-ray view of a sixth embodiment of the locking means;

FIG. 15 is an x-ray view of a seventh embodiment of the locking means that uses a rod or handle; and

FIG. 16 shows an additional embodiment of the present invention that features an optional pocket.

### DETAILED DESCRIPTION OF THE INVENTION

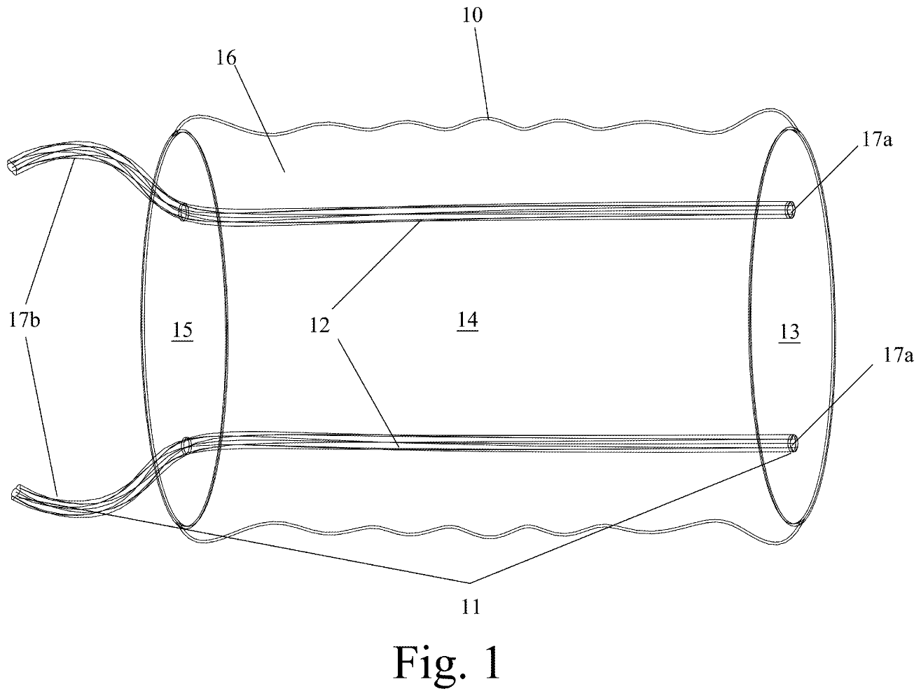

FIG. 1 shows a first embodiment of a pillow 10 featuring the tension device 11 in use with a pillow that is a combination of a knife edge pillow and a box edge pillow. Specifically, FIG. 1 shows two cords 12 that are attached to a first inner surface or edge 13 of a pillow 10 and extend through the interior 14 of the pillow 10 to a second edge or surface 15 of the pillow 10. In this embodiment, the second edge 15 of the pillow is directly opposed to the first edge 13. The cords 12 traverse the interior 14 and exterior 16 of the pillow and pass through the second edge 15 of the pillow 10 such that a free end 17b of each cord 12 exits the pillow 10 via the second edge 15. The end of each cord 12 that is opposite the free end 17b that exits the pillow 10 is referred to as the first end 17a of the cord 12. The first end 17a of the cord 12 is attached in some manner to a surface 15 of the pillow 10. In some embodiments, the first end 17a may also traverse the interior 14 and exterior 16 of the pillow 10 and attach to the exterior 16 of the pillow 10. In other embodiments, the first end 17a of the cord 12 is attached to a surface of the interior 14 of the pillow 10. Preferred embodiments and the inventor's anticipated best mode include at least two cords 12 attached to a surface on the interior 14 or exterior 16 of the pillow 10 at or near the first edge 13 of the pillow 10. When applied to other shapes and sizes of pillows 10, there may not be a knife edge to which the first end 17a can be attached. In those cases, the first end 17a can be attached to any surface inside the pillow 10 or can attach to any surface on the exterior 16 of the pillow and enter the pillow through openings in that surface or an adjacent surface. Some embodiments even have the first end of the cords attached to the stuffing inside the pillow. The positioning of the attachment of the first end 17a of the cord(s) 12 allows the user to compress the contents of the interior 14 of the pillow by pulling on the free end(s) of the cord(s) 17b and thereby changing the shape and firmness of the pillow. While this embodiment uses two cords, any number of cords can be used as part of this tension device.

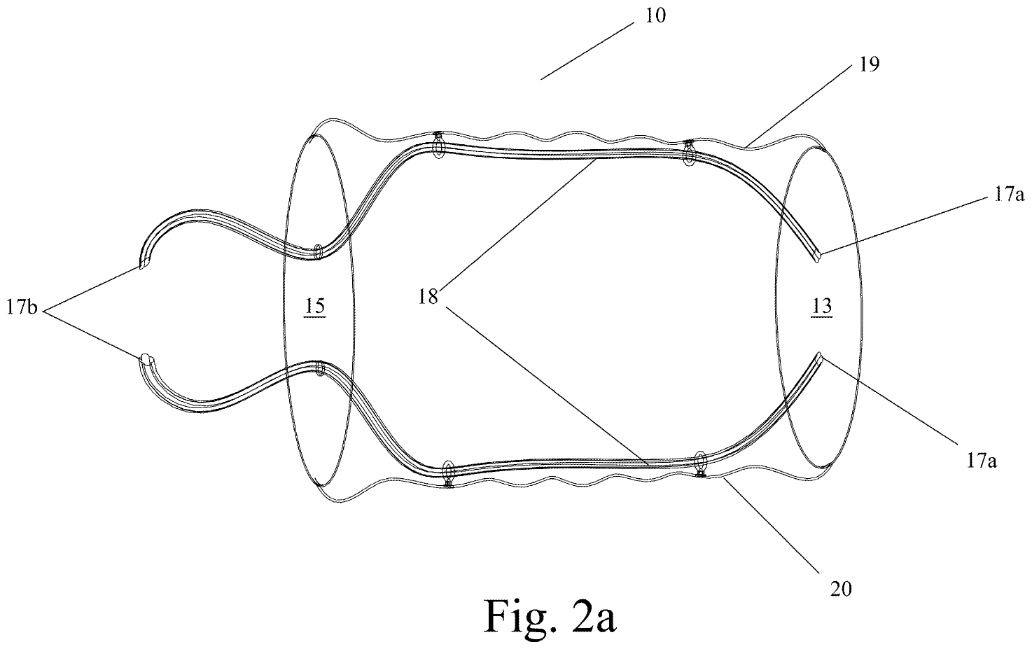

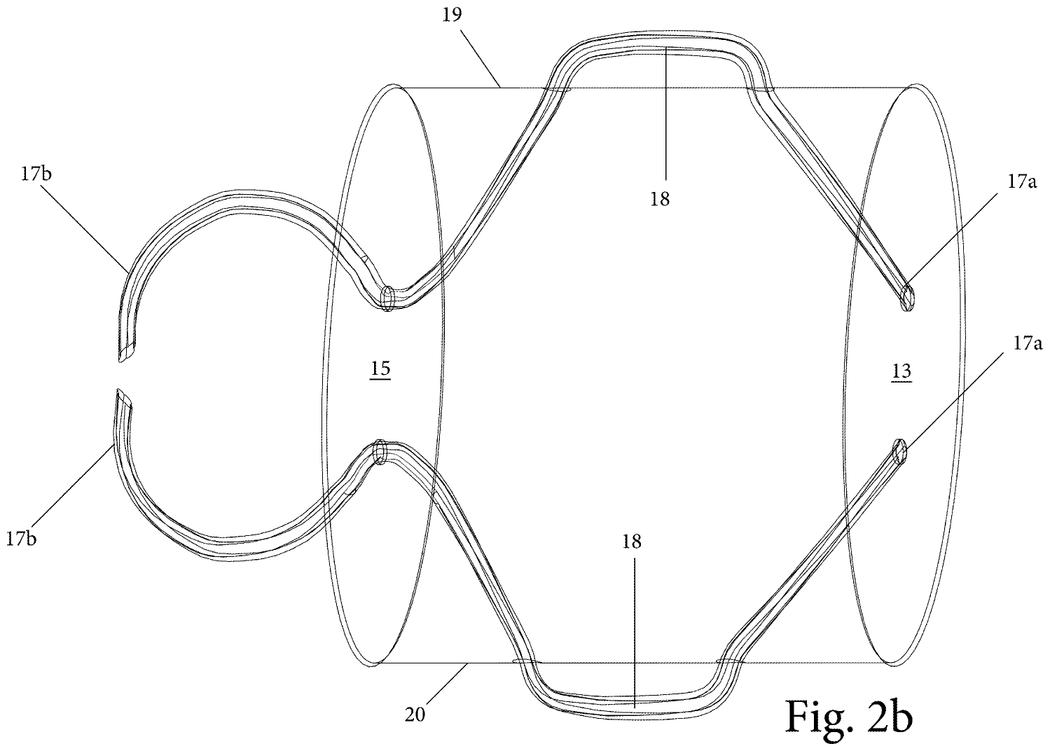

FIG. 2A shows an alternate embodiment that has two cords 12 that are each attached to the pillow 10 at more than one point. In this embodiment, the cords 12 are attached to a first interior surface 13 of the pillow at the first end 17a of each cord. Between the first end 17a and the free end 17b of each cord 12 there is a middle section 18 of the cord 12. This middle section can be thought of as the entire length of cord 12 that is between the first end 17a and the free end 17b. This middle section 18 of each cord 12 can be attached to other surfaces on or in the pillow.

The embodiment shown in FIG. 2A has a middle section 18 that attaches to a surface of the pillow 10 that is not the same surface to which the first end 17a of each cord 12 is attached. In this embodiment, each cord 12 attaches to a top 19 or bottom edge 20 or surface of the pillow 10 that is adjacent to the first edge 13 of the pillow 10. The free end 17b of each cord 12 exists via an opposing second surface or edge 15 of the pillow as in the embodiment described immediately above. FIG. 2A shows that one cord 12 is attached to the first edge 13 and an adjacent top or third surface or edge 19 of the pillow 10. The second cord 12 is attached to a bottom or fourth surface or edge 20 of the pillow 10 that is directly opposite the third surface or edge 19.

While some embodiments will merely have a portion of the middle portion or section 18 of one or more of the cords 12 attaching to an interior 14 of the pillow 10 some other embodiments will have a middle section 18 that passes through a portion of the surface to which it attaches. For example, in FIG. 2B, each cord attaches to or passes through the first surface 13 via their respective first ends 17a and then the cord 12 passes through an adjacent top 19 or bottom 20 edge or surface of the pillow 10 and reenters the same surface before exiting the second surface or edge 15 of the pillow 10 that is opposite the first edge 13. In other words, after attaching to or passing through the first surface 13, the cord 12, then traverses a portion of the interior 14 of the pillow 10 before the middle portion 18 passes through a third surface 19, 20 or edge of the pillow that is adjacent to the first 13 and second surfaces 15 or edges. When the user pulls on the free ends 17b of the cords 12 the cords pull multiple surfaces or edges of the pillow from multiple angles to compress the interior of the pillow 10.

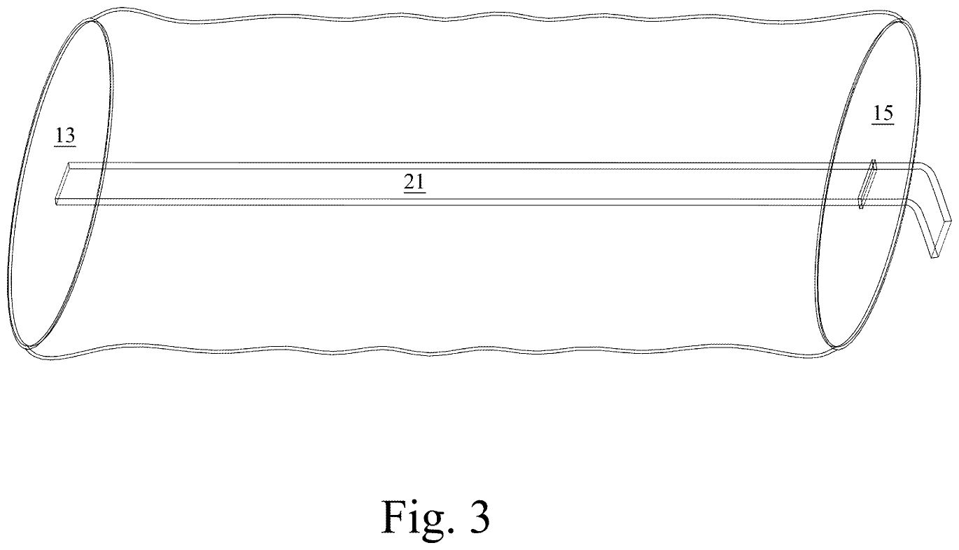

FIG. 3 shows a third embodiment of the pillow and tension device. In FIG. 3, the cords have been replaced with a single strap 21 integrated into or attached to the pillow 10. The user adjusts the pillow in the same manner, i.e. they pull on the free end 17b of the strap 21 that is attached to a first edge 13 of the pillow 10 and thereby pull the first edge or surface 13 of the pillow 10 towards a second edge or surface 15 of the pillow 10 compressing the stuffing inside the pillow 10.

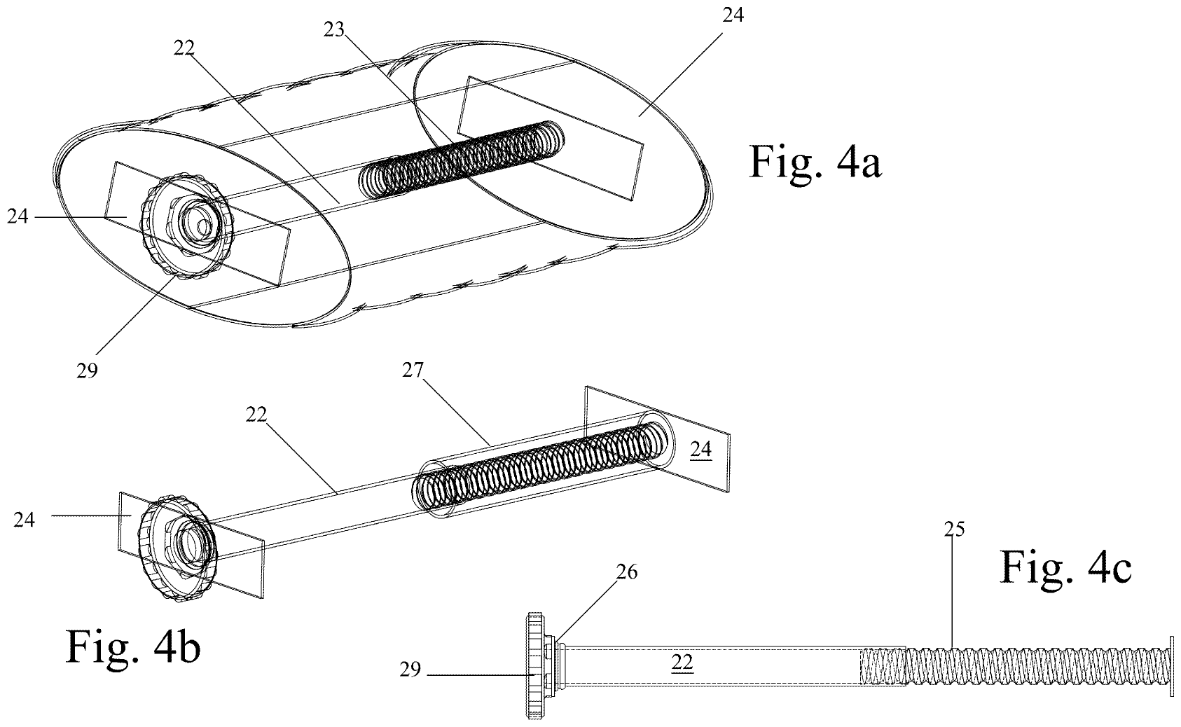

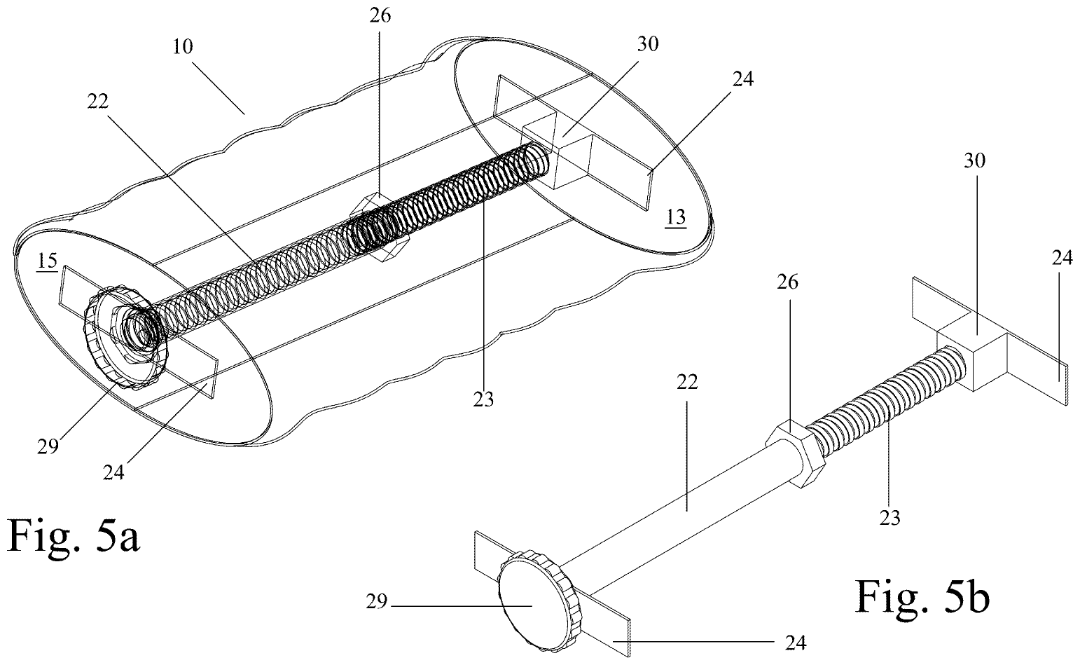

FIGS. 4A, 4B and 4C show a fifth embodiment that includes an internally threaded tube or cylinder 22 and an externally threaded rod 23 that when turned in one direction engages the threads in the cylinder 22. An end of each of the cylinder 22 and/or the rod 23 is attached to a structure in the interior or on the exterior 16 of the pillow 10 such as a flattened handle 24. In preferred embodiments, the cylinder 22 exits a second edge 15 of the pillow such that the user can rotate the cylinder 22 by hand. The cylinder's rotation causes the external threads 25 on the rod 23 to engage with the cylinder 22 and “screw into” the internally threaded cylinder 22. A portion of either the rod 23 and/or cylinder 22 can extend out of the pillow 10 such that a user can turn the rod 23 or cylinder 22 to engage or disengage the threads 25 of each. Some embodiments will have a nut 26 that attaches to the pillow 10 but still allows the cylinder 22 to rotate within the nut 26. Other versions feature a nut at the junction of the cylinder 22 and the rod 23 as can be seen in FIG. 5B. One of the ends of the rod 23 or cylinder 22 will be attached to a first edge or surface 13 of the inside or outside of the pillow 10. When the user turns the cylinder 22 with respect to the threaded rod 23, the threads of the rod 23 engage the threads of the cylinder 22 thereby forcing the handle 24 or other structure to which the threaded rod 23 is attached to move toward the first edge 13 of the pillow 10 with the cylinder 22. An optional sleeve 27 can be placed over the threaded portion 25 of the rod 23 or the rod 23 and the cylinder 22 together to prevent the threads from engaging with the stuffing inside the pillow 10. A skilled artisan will appreciate that this arrangement can be modified and reversed. For example, the threaded rod 23 could exit an edge of the pillow 10 and have a knob 29 attached thereto while the cylinder 22 is attached to a portion of the pillow 10 or another structure that is attached to the pillow 10 such as a handle 24. These embodiments can also include an optional sleeve 27 that fits over the exposed threads of the externally threaded rod 23 that helps to prevent those threads 25 from engaging with the stuffing inside the pillow 10.

FIGS. 5A and 5B show a similar embodiment in which the cylinder 22 and rod 23 are moved by a motor 30. In preferred embodiments and the inventor's anticipated best mode, an end of the threaded rod 23 is operably attached to a motor 30 that turns the rod 23 such that it screws into the cylinder 22 as above, thereby compressing the contents of the interior of the pillow 10. Alternately, the motor 30 can be operably connected to the cylinder 22.

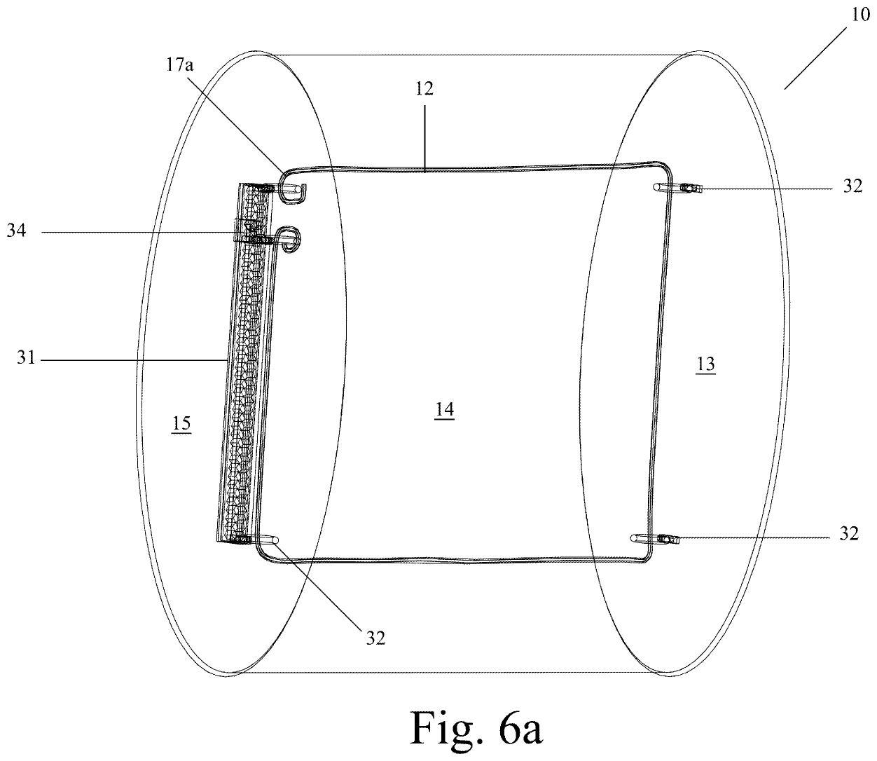

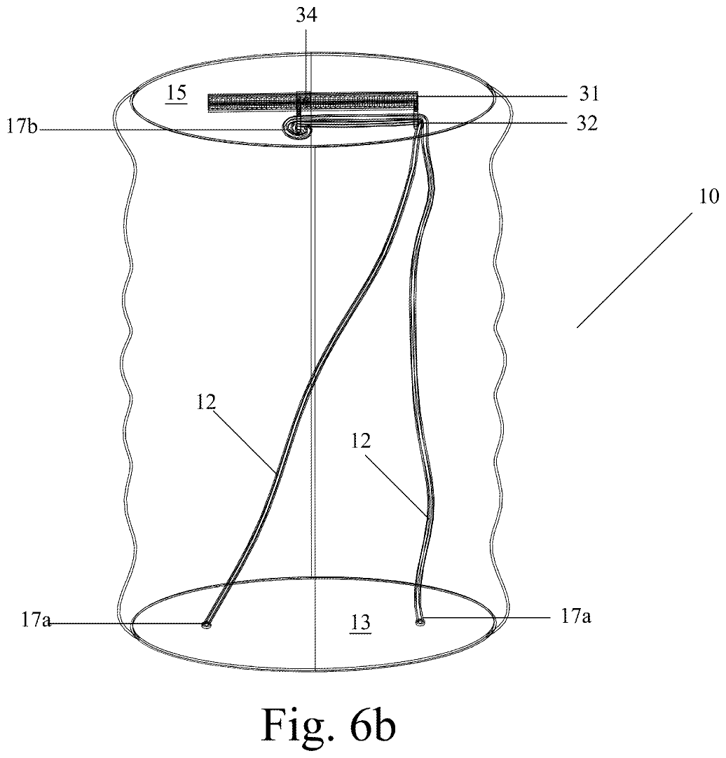

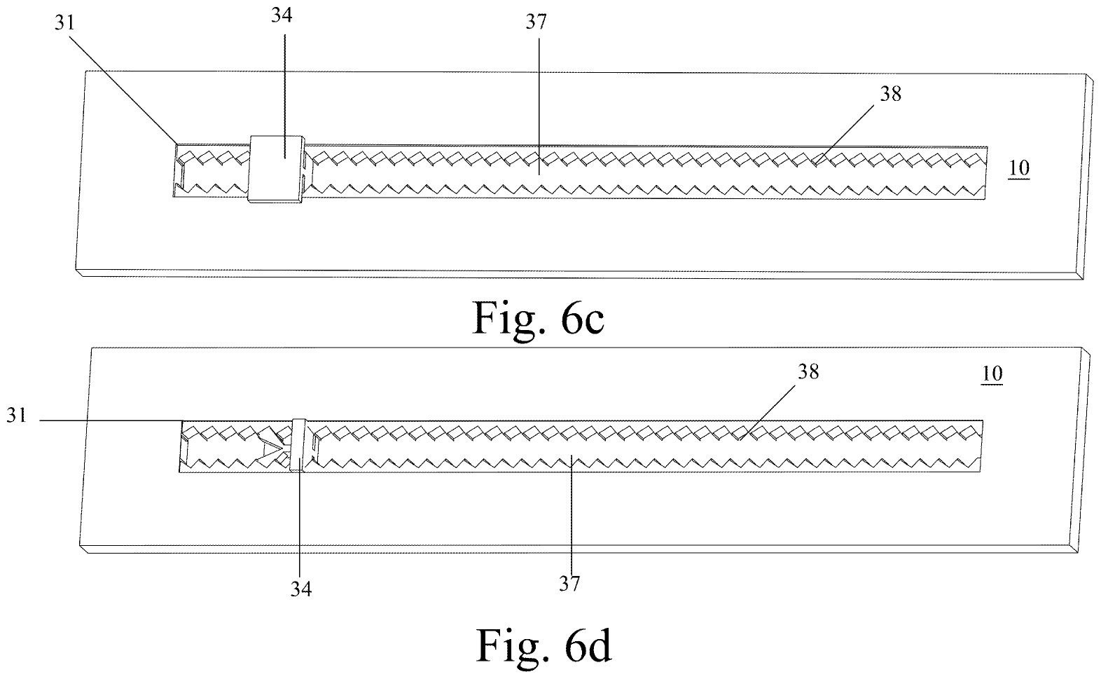

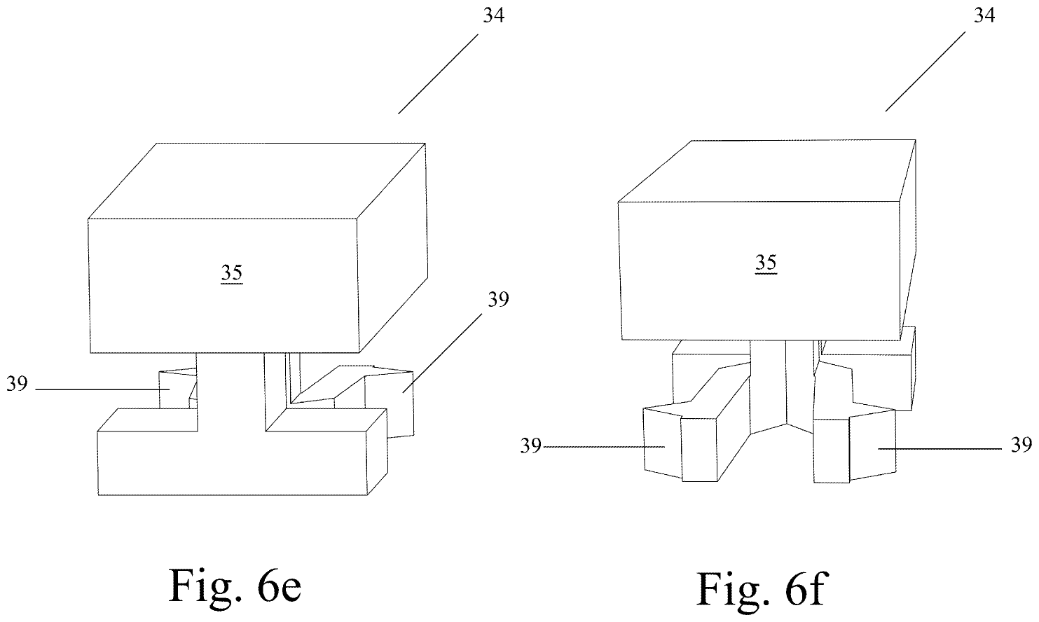

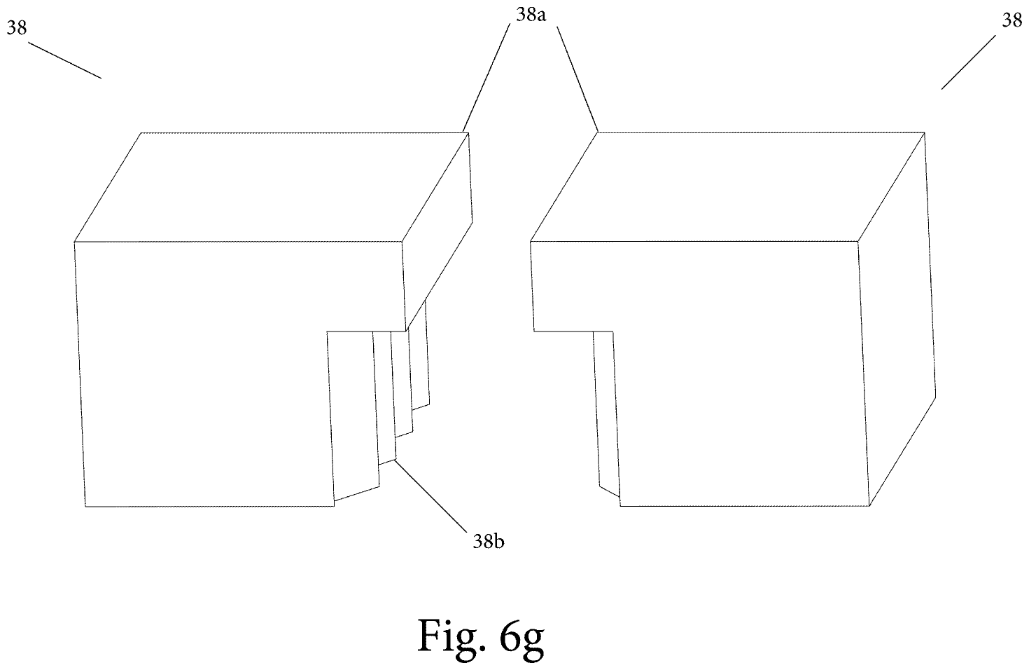

FIGS. 6A through 6G show additional embodiments of a pillow 10 featuring the tension device 11 that uses a slide to manipulate the cords 12. The embodiment in FIG. 6A features a single cord 12 that is attached to a slide mechanism 31, or some other fixed point in the pillow, at a first end 17a and then traverses at least a portion of the interior 14 of the pillow 10 until it reaches a first inner surface or edge 13 of the pillow 10. In this particular embodiment, the first surface 13 is directly opposite or on the opposing side of the pillow 10 from the second edge or surface 15 that includes a thumb switch 34 and slide mechanism 31, but a skilled artisan can appreciate the location of this attachment point can be varied. The first surface 13 features one or more loops or pulleys 32 or some other structure through which the cord 12 can pass. In this version, the cord 12 then passes through a second pulley or loop 32 attached to a different portion of the same surface 15 of the pillow 10 before it traverses the interior 14 of the pillow 10, passes through a third pulley or loop 32 and then attaches to a thumb switch 34 that is positioned to slide along the length of a slide mechanism 31.

When the user moves the thumb switch 34 in the slide mechanism 31 in one direction, the thumb switch pulls on the cord that passes through the interior 14 of the pillow 10 and the pulley(s) 32 thus pulling the opposing first surface 13 of the pillow towards the second surface or edge 15 that features the slide mechanism 31. When the thumb switch 34 is moved in the opposite direction, the cord experiences a decrease in tension and the pillow 10 is allowed to “relax” into its uncompressed state. Similar to the embodiment shown in FIG. 2, the pulleys 32 can be replaced with holes (not shown) that allow the cord 12 to pass outside of the pillow 10 from one point and to enter the pillow 10 at another point instead of passing through loops or pulleys 32.

FIG. 6B shows an alternate version of the same embodiment that uses two cords 12 attached at different places to the interior of the pillow 10. In this embodiment, the first end 17a of each cord 12 is attached to a portion of the interior or the exterior 16 of the pillow 10 and the free end 17b of each cord 12 passes through a pulley or ring 32 before attaching to the thumb switch 34. As above, moving the thumb switch 34 in one direction pulls on the cords 12 causing the pillow to contract while moving the thumb switch 34 in the opposite direction decreases the tension on the cords 12 decreasing the deformation of the pillow 10.

FIGS. 6C through 6D show the thumb switch 34 and slide mechanism 31 in more detail. 6C is a top view of the slide mechanism 31 and 6D is a bottom view of same. The slide mechanism 31 itself is an opening 37 flanked on either side by tracks 38 integrated into a surface of the pillow. The thumb switch 34 is configured to engage the tracks 38 as it moves within the opening 37 of the slide mechanism 31. The thumb switch 34 is shown in more detail in FIGS. 6E and 6F. FIG. 6G shows a close up of the tracks 38 that are engaged by the pawls 39. The thumb switch 34 has one or more pawls 39 (arms having free ends that extend away from the body 35 of the thumb switch 34) that engage the tracks 38 to hold the thumb switch 34 in position within the slide mechanism 31. The tracks 38 fit into the space or groove 40 between the body 35 and the pawl(s) 39. The tracks 38 have a body 38a that fits into the space or groove 40 of the thumb switch 34 as well as teeth 38b that are engaged by the pawl(s) 39. As the thumb slide 34 is moved through the opening 37, the pawl(s) 39 on the thumb slide 34 engage with the tracks allowing the thumb slide to remain in position due to friction between the pawl(s) and the tracks when the user releases the thumb slide 35.

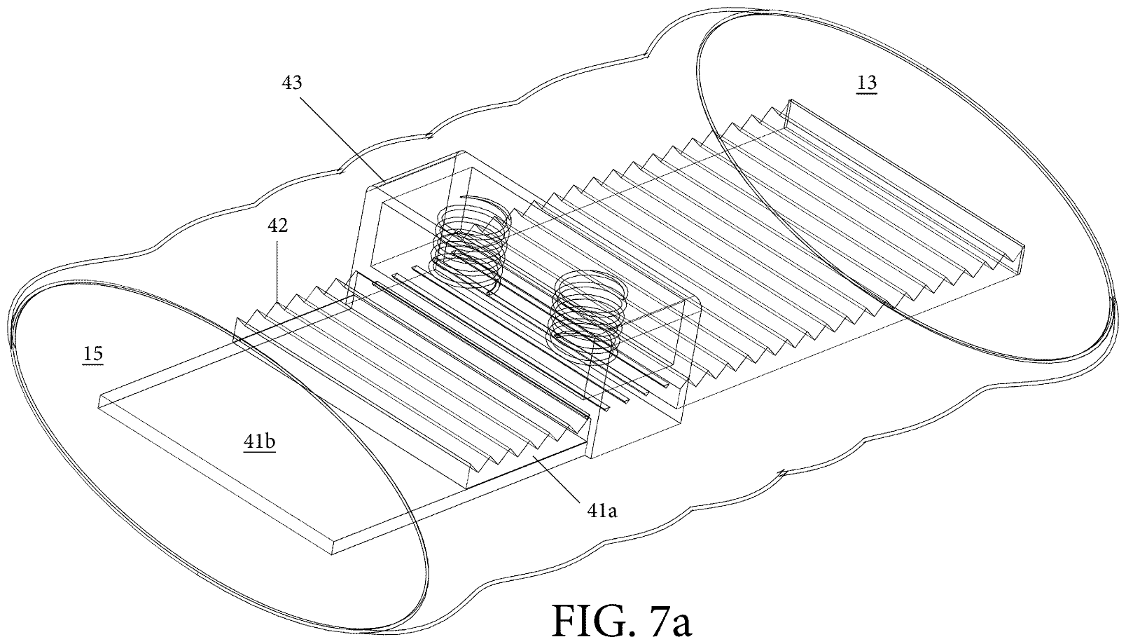

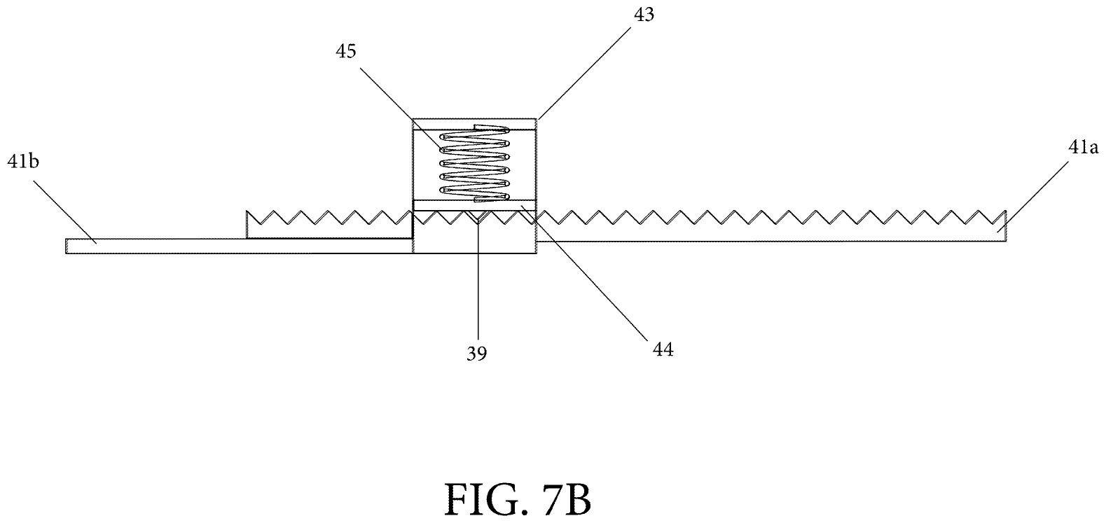

FIGS. 7A and 7B show an additional embodiment using a device similar to a ratchet assembly to adjust the internal configuration of the pillow. More specifically, the pillow 10 contains an elongated, flexible bar 41a running through the interior of the pillow that has a plurality of teeth 42 on a surface. The flexible bar 41a with teeth 42 is accompanied by a separate flexible bar 41b that is attached to a housing 43 that contains a pressure plate 44 with a pawl 39 on one side that engages with teeth 42 located along a top surface of the flexible bar 41a with teeth 42. The respective flexible bars 41a and 41b are attached to opposite edges or surfaces of the pillow 10. The housing 43 attached to the flexible bar 41b without teeth is positioned to allow the bar 41a with teeth 42 to slide into and through the housing 43. Preferred embodiments of the housing include springs 45 located in the housing 43 and positioned such that they exert a downward force on the pressure plate 44, i.e. the springs 45 push the pressure plate 44 towards the bar 41a with teeth 42. The pressure plate 44 has a pawl 39 that engages with the teeth 42. Preferred embodiment and the inventor's anticipated best mode use springs that produce enough force to hold the pawl 39 in place when it engages the teeth 42, but not so much force that a lateral force along the length of the bar will not dislodge the pawl 39 from the teeth 42 when the user moves the housing 43 along the length of the bar 41. The housing 43 can be gripped and physically moved by the user from the outside of the pillow, i.e. without opening the pillow 10. As the user manipulates the housing 43, the housing is moved along the length of the flexible bar 41a with teeth 42 pulling the flexible bar 41b without teeth and the side or edge of the pillow to which it is attached along with it.

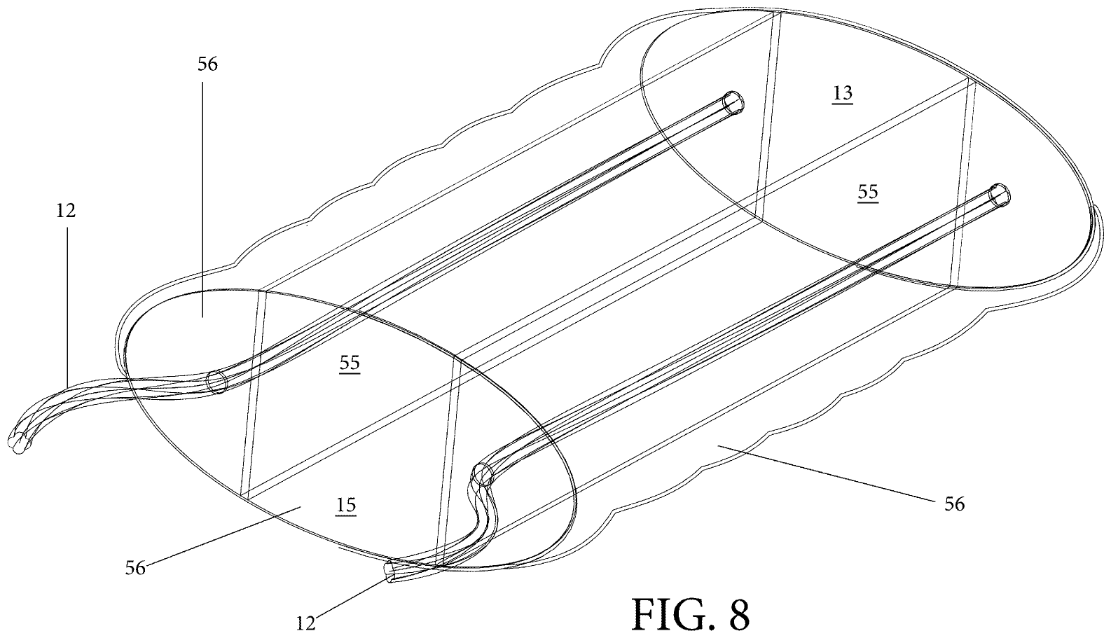

FIG. 8 shows another embodiment of the pillow 10 and tension device 11 in which the interior of the pillow features panels 55 that separate the interior 14 of the pillow 10 into a plurality of sections 56. In this embodiment, there are two vertically oriented panels 55 that extend from a first edge 13 of the pillow 10 to a second edge 15 of the pillow 10. Preferred embodiments of the panels 55 also attach to the top 19 and bottom 20 surfaces of the pillow 10 as well thereby completely dividing the interior 14 of the pillow 10 into three sections 56. The sections can be filled with different types of stuffing so that they compress differently when the cords 12 are pulled by their free ends 17b to pull the first edge 13 toward the second edge 15.

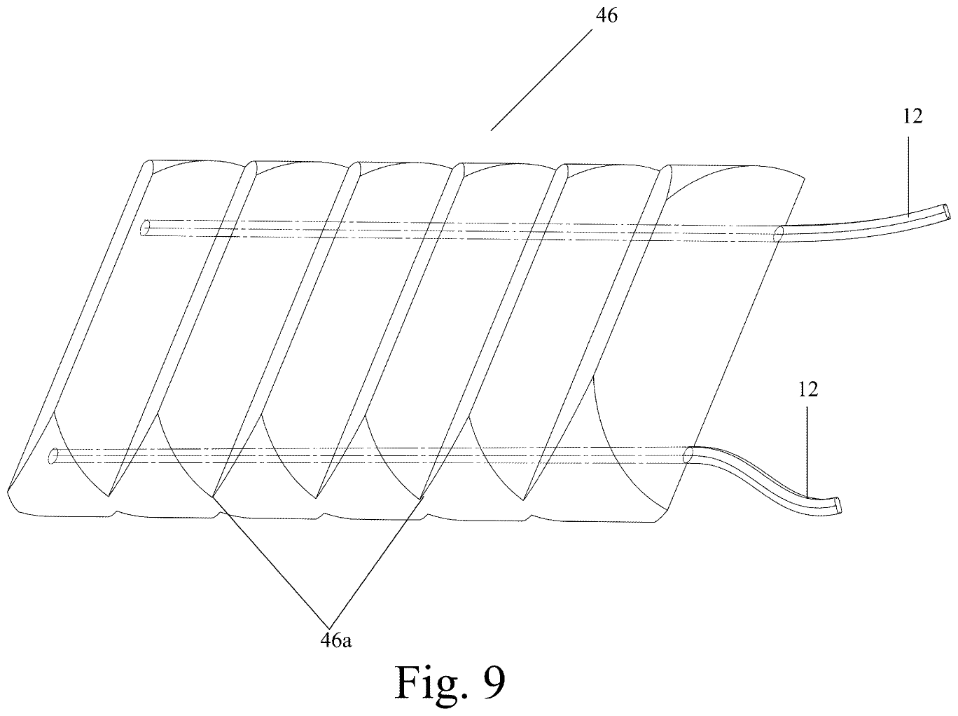

FIG. 9 shows an alternate arrangement for the stuffing 46 inside the pillow 10. In this embodiment, the stuffing 46 takes the form of a folded sheet with a plurality of folded sections 46a through which the cord 12 or strap (not shown) passes as it traverses the interior of the pillow. As the user pulls on the cord(s) 12, the folded sections fold one on top of the other to form a compressed accordion-like structure as the first edge 13 is pulled toward the second edge 15.

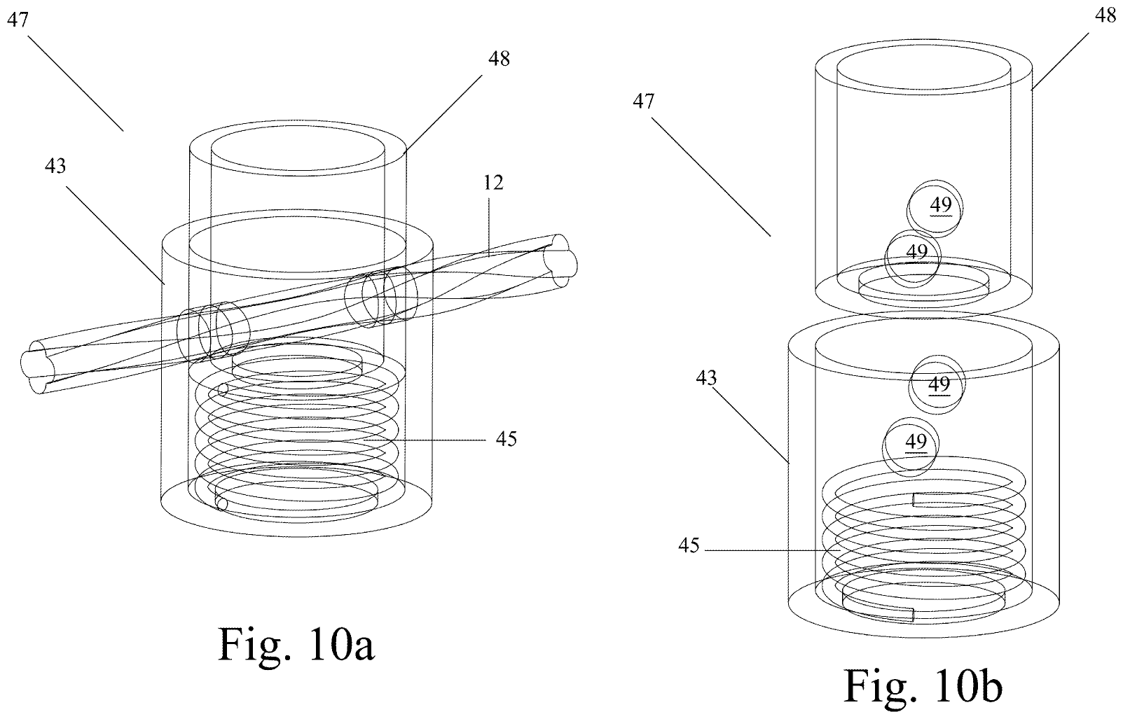

In addition to the internal arrangement of the pillow 10 and tension device 11, the inventor has come up with a number of different locking means to use to hold the cord(s) 12 in position once the user has adjusted the pillow 10 to its desired firmness. One such locking means is a cord lock 47 as shown in FIGS. 10A and 10B. A cord lock 47 has a barrel or housing 43 that is at least partially hollow inside. The housing 43 holds a spring 45 that is positioned in the housing 43 below a plunger 48. Both the housing 43 and the plunger 48 feature complementary holes 49 through which a cord 12 can pass. When the plunger 48 is pressed downward into the housing 43 and towards the spring 45, the holes 49 in the housing and the plunger align and the cord 12 is free to slide or move. When the pressure on the plunger 48 is released, the spring relaxes and forces the plunger upward and partially out of the housing 43. At that point, any cord 12 passing through the holes 49 in the plunger 48 and housing 43 is compressed and stuck in place.

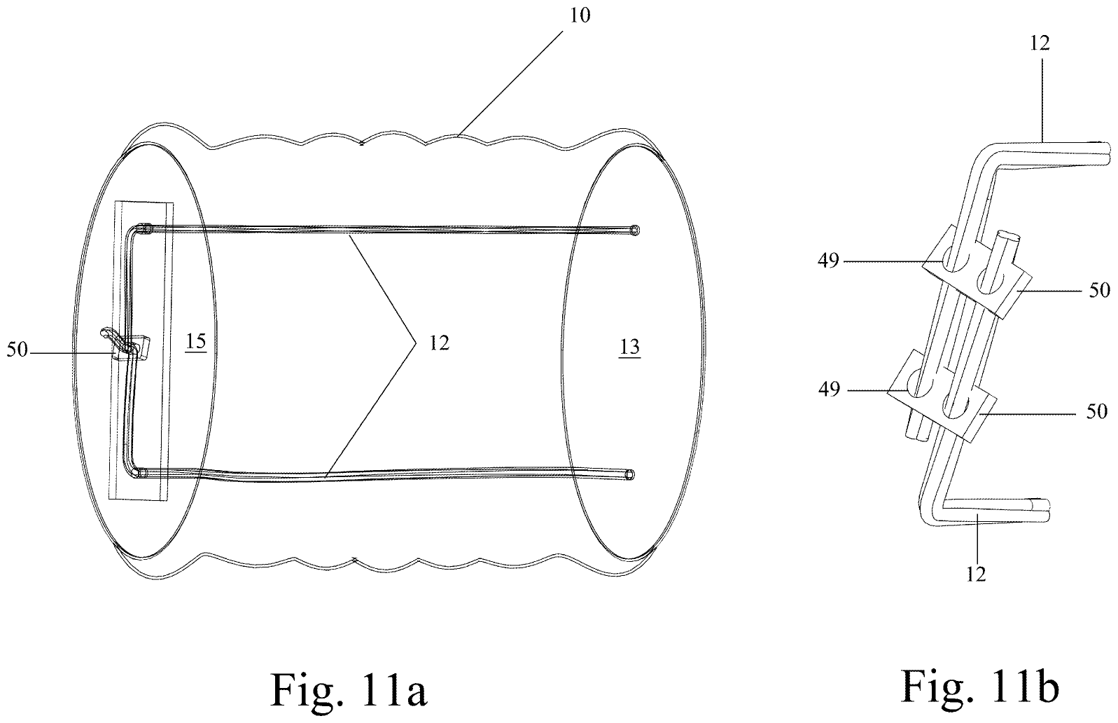

FIGS. 11A and 11B show another embodiment of the locking means. In this embodiment, each of two cords 12 is attached or fixed to a tab 50 with at least one hole 49 in it. When used with two cords 12, each of two tabs 50 is attached at a single point to one of the cords 12 and has a hole 49 in it that allows the other cord 12 to pass through. Therefore, each tab 50 has a cord attached to it and a cord passing through it. The user can apply tension to either cord 12 by manually pulling on it and in doing so slide the other cord 12 through the hole 49 on one of the tabs 50. This process is repeated for the other cord 12. When the user stops applying force to the cords 12, the cord attached to each tab 50 applies tension to its respective tab causing it to pivot or turn and lay against the pillow 10. As the cord 12 pulls one side of the tab 50, the cord 12 is caught in the hole 49 passing through that tab 50 as the tab 50 turns sideways. When both cords 12 are pulled and then released, each slide holds the cord passing through its respective hole in place with friction.

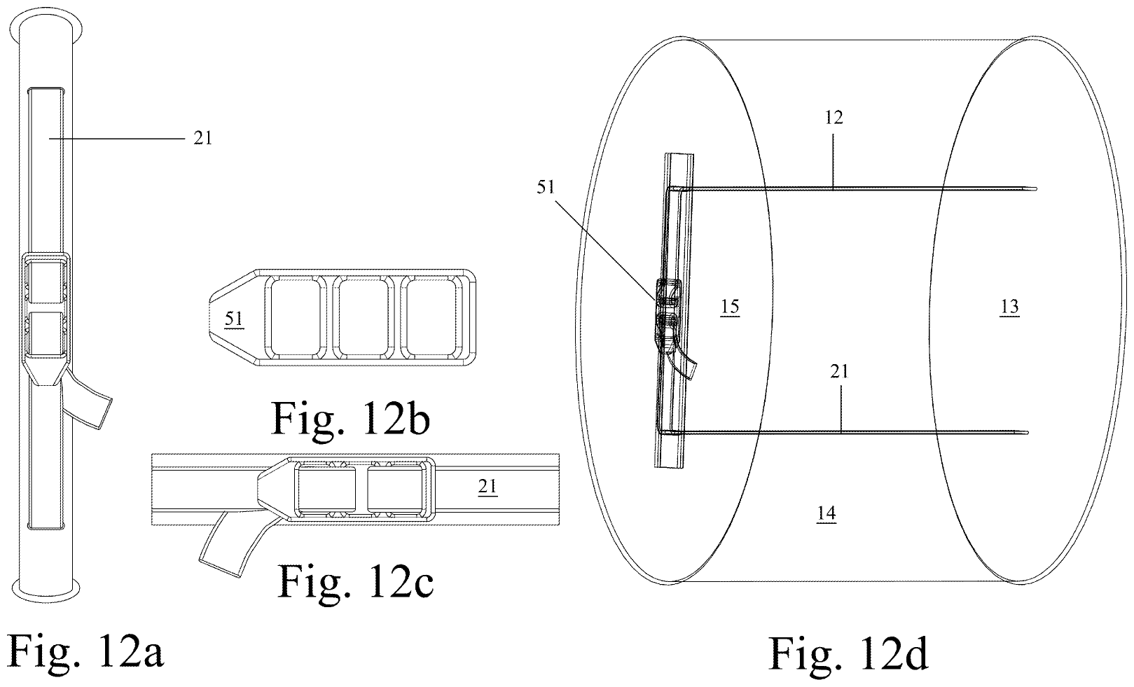

FIGS. 12A through 12D show another embodiment in which the tab 50 is replaced with a buckle 51 to which one cord 12 or strap 21 is attached and the with which the other cord 12 or strap 21 can engage.

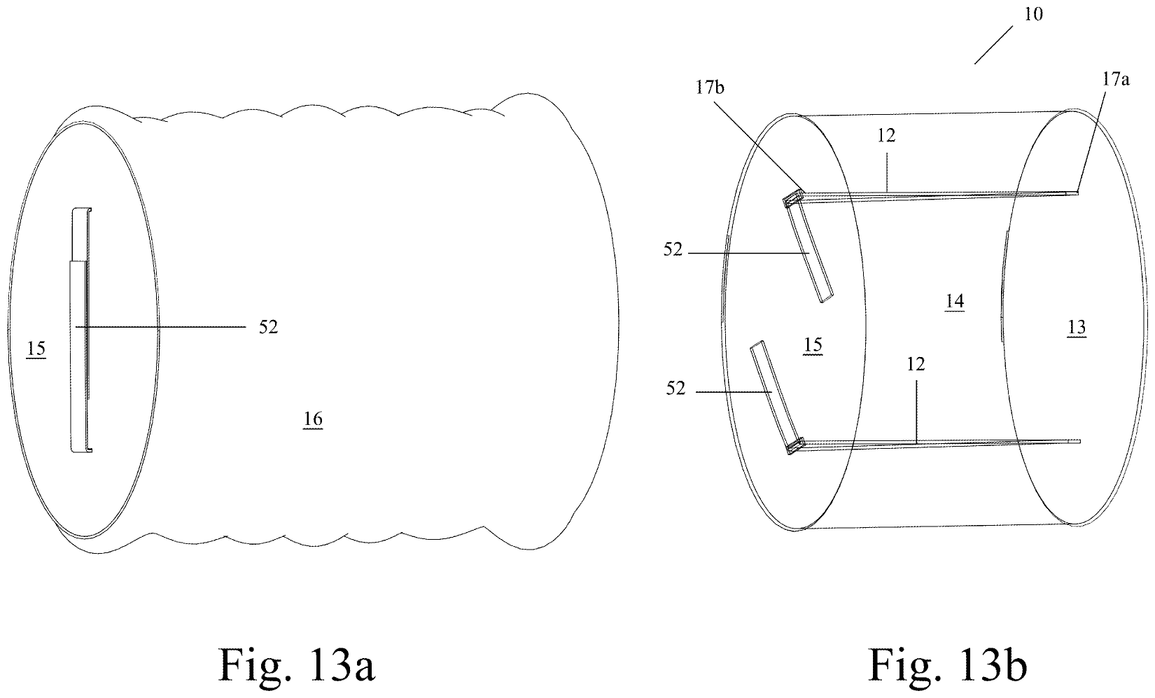

FIGS. 13A and 13B show another embodiment of the locking means that uses Velcro or hook and loop fasteners to secure the free ends 17b of the cords 12 or straps 21 that exit the pillow 10. Specifically, the pillow 10 can feature one part of a hook and loop fastener system 52 on an exterior 16 of the pillow 10 positioned to be in reach of the free end 17b of any cord/strap 12,21 that passes out of the pillow 10 that also features the other half of the hook and loop system 52. The user simply pulls on each cord/strap 12,21 until the desired pillow configuration is reached and then attaches each cord/strap 12,21 to the other half of the hook and loop system 52 on the exterior 16 of the pillow 10. Alternately, as shown in FIG. 10B, the straps can each feature a portion of a hook and loop fastener system 52 on their respective free ends 17b that can be engaged when the straps 21 have been pulled to the desired position.

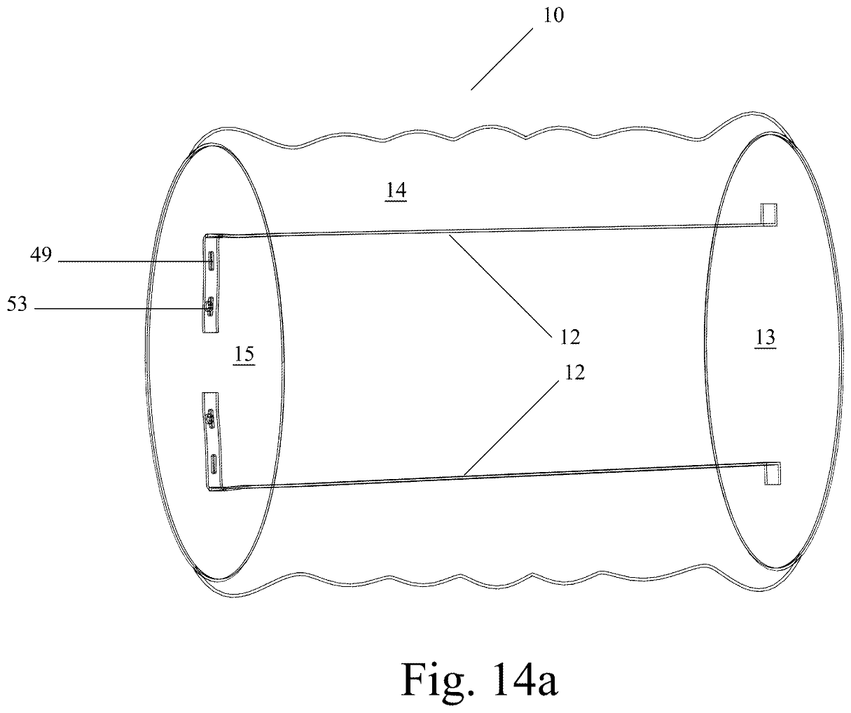

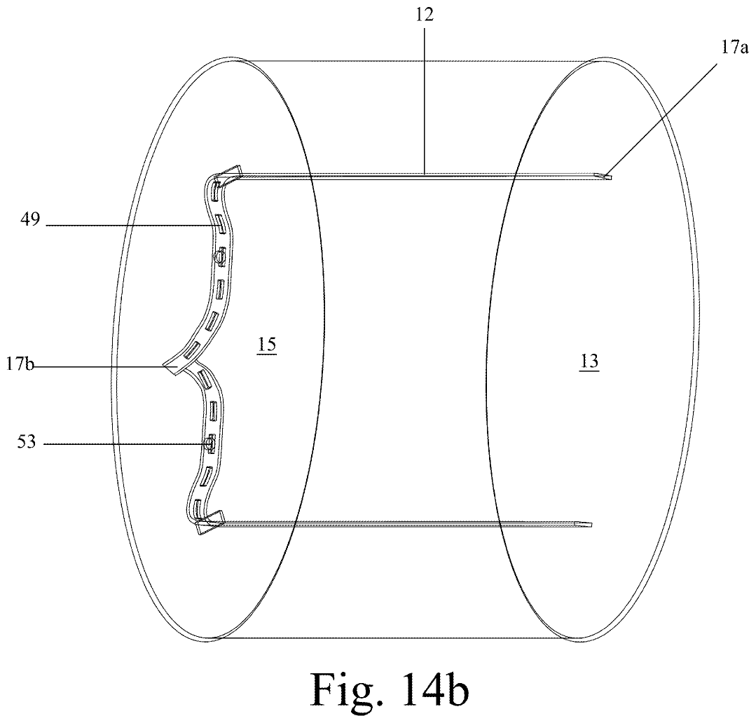

FIGS. 14A and 14B show another set of embodiments with different locking means. In these embodiments, the cords 12 feature buttons and/or buttonholes 49. Buttons or snaps can be positioned on the exterior 16 of the pillow 10 near the site where each free end of the cord 12 exits the pillow's interior 14. Buttons 53 can also be features on the cords 12 themselves. Of course, the cords 12 can be pulled into their desired position and then fixed in place using the buttons to engage buttonholes either on the cords 12 or the exterior 16 of the pillow 10.

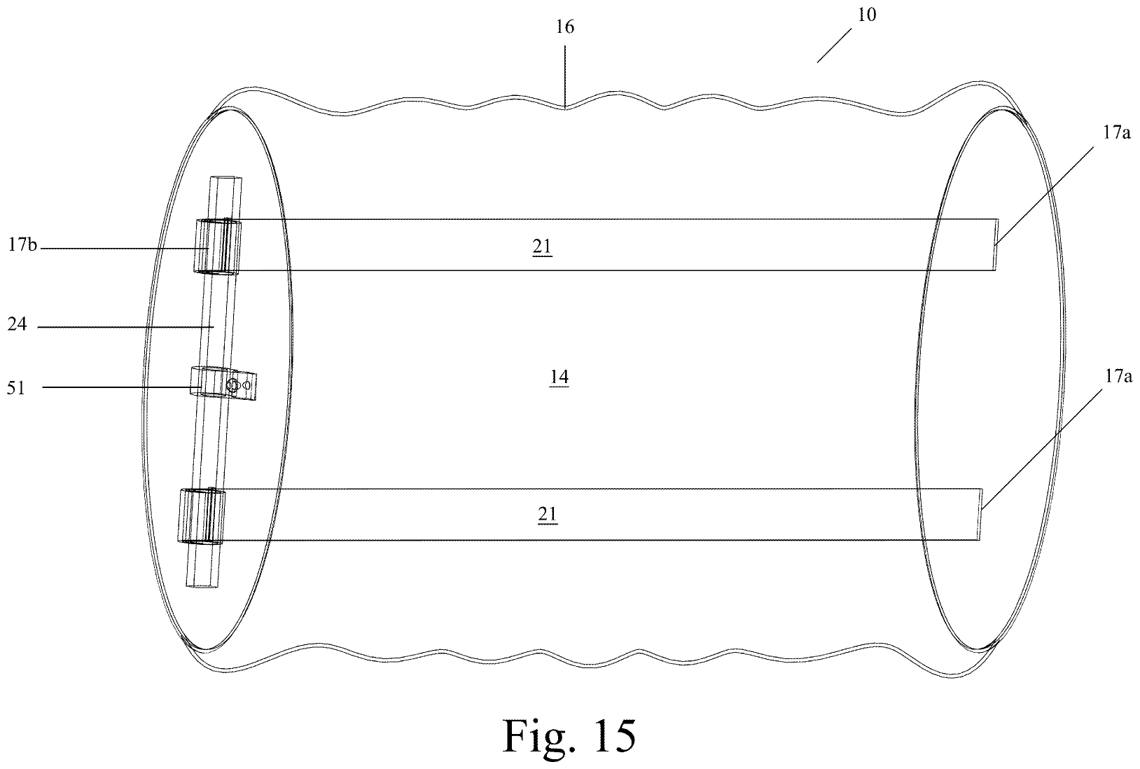

FIG. 15 shows another embodiment that has a rod 23 or handle 24 attached to the free end(s) 17b of straps or cords 12 that have exited the pillow 10. In these embodiments, the user can use a single handle 24 to pull on more than one strap 21 or cord 12. Once the user pulls on the straps/cords 21,12 they can wrap the free ends 17b of those same straps/cords 21/12 around the handle 24 to take up the extra slack. A button, snap, buckle or other means of securing the handle 24 can be used to attach the handle to the exterior 16 of the pillow 10. Locking either end of the handle in place using the buckles 51 prevents the handle from moving and the straps 21 from coming unwound.

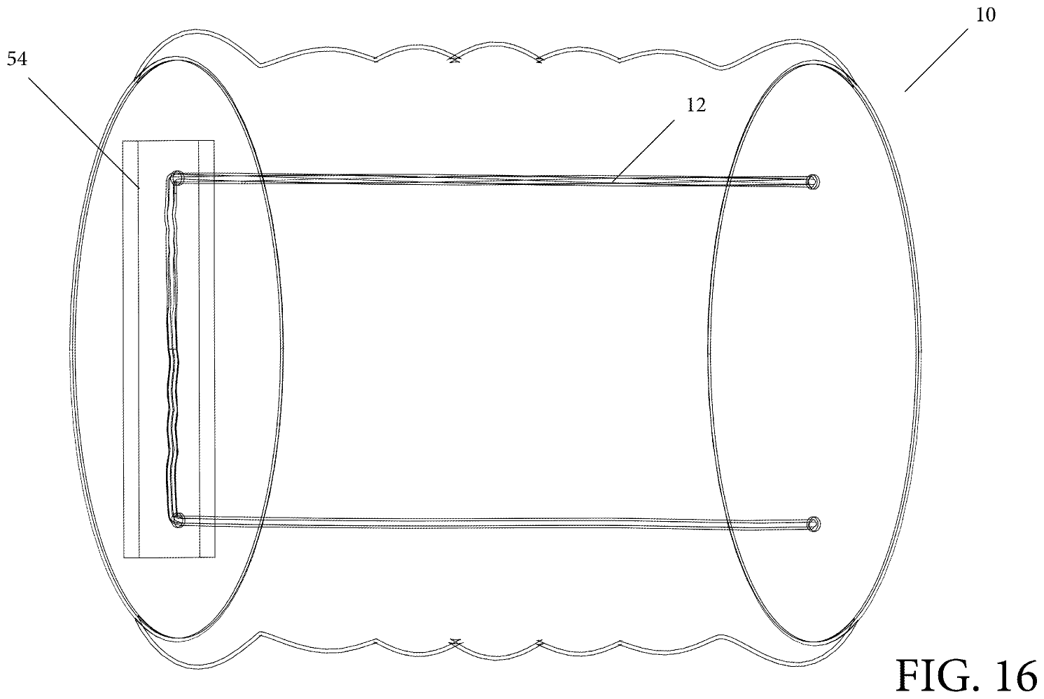

FIG. 16 shows an optional pocket 54 or cover that can be integrated into the outside of the pillow 10 to hide or store the locking means and/or the free ends of the cords/straps 12,21.

The advantages of the present invention include, without limitation, the ability to customize the size, shape and firmness of a pillow without opening the pillow to add or remove anything. Moreover, there is no need for multiple cushions or pillows to achieve this benefit. The tension device described in this disclosure can consist of a plurality of cords, straps or other elongated lengths of material depending on the needs of the user.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above-described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A tension device for use with a cushion having an interior and an exterior, said interior containing stuffing, comprising:
at least one elongated length of material, having a first end and a free end;
wherein a first end of the at least one elongated length of material is attached to a first surface of the cushion, and
the free end of the elongated length of material traverses the interior and the exterior of the cushion through a second surface of the cushion and includes a locking means.

2. The tension device of claim 1 further comprising a middle section of the at least one elongated length of material between the first end and the free end that is attached to a third surface of the cushion.

3. The tension device of claim 1 wherein the at least one elongated length of material passes through a first surface of the cushion, traverses a portion of the interior of the cushion, and exits through the second surface of the cushion directly opposed to the first surface of the cushion and wherein a middle portion of the at least one elongated length of material traverses a third surface of the pillow that is adjacent to the first and second surfaces of the cushion.

4. The tension device of claim 1 further comprising:
a plurality of elongated lengths of material each having:
a first end that is attached to a first surface of the pillow or cushion, and
a free end that traverses the interior of the cushion and the exterior of the cushion through a second surface of the pillow or cushion and features the locking means.

5. The tension device of claim 4 further comprising a middle section of each of the plurality of elongated lengths of material between the first end and the free end and wherein the middle section of at least one of the plurality of elongated lengths of material is attached to a third surface of the cushion.

6. A tension device for use with a cushion having an interior and an exterior, said interior containing stuffing, comprising:
a housing containing a pressure plate attached to a pawl and a spring; wherein said housing is attached to a flexible bar without teeth; and
a flexible bar having a plurality of teeth configured to engage with the pawl and that inserts into and passes through the housing.

7. The tension device of claim 1 wherein the at least one elongated piece of material comprises:
an internally threaded cylinder, and
an externally threaded rod; and
wherein the externally threaded rod can be screwed into the internally threaded cylinder.

8. The tension device of claim 7 further comprising a motor operably connected to an end of the internally threaded cylinder or the externally threaded rod.

9. A tension device for use with a cushion having an interior and an exterior, said interior containing stuffing, comprising at least one elongated length of material each having a first end, a middle portion that traverses the interior of the pillow and a free end that attaches to a thumb switch positioned to move along the length of a slide mechanism.

10. The tension device of claim 9 wherein further comprising:
at least two elongated lengths of material each having:
a first end attached to a different surface of the pillow,
a middle portion that traverses the interior of the pillow and
a free end that attaches to the thumb switch that is positioned to move along the length of a slide.

11. The tension device of claim 9 wherein the first end is attached to a slide mechanism or a surface of the pillow adjacent to the slide mechanism and the middle portion passes through at least one pulley or loop of material attached to a portion of the pillow that does not include the slide mechanism.

12. The tension device of claim 4 wherein the stuffing inside the cushion is folded into the form of a pleated sheet through which the at least two elongated lengths of material pass.

13. The tension device of claim 1 wherein the locking means comprise a handle attached to the free end of the elongated length of material and wherein the handle features a fastener to fasten the elongated length of material in place.

14. The tension device of claim 2 wherein the locking means comprise a handle attached to the free end of the elongated length of material and wherein the handle features a fastener to fasten the elongated length of material in place.

15. The tension device of claim 4 wherein the locking means comprise a handle attached to the free ends of each of the elongated lengths of material and wherein the handle features a fastener to fasten each of the elongated lengths of material in place.
